(19) United States
(12) Patent Application Publication
(10) Pub. No.: US 2026/0169613 A1
(43) Pub. Date: Jun. 18, 2026

(54) SPATIOTEMPORAL DATA AUGMENTATION METHODS FOR RECOMMENDATION SYSTEMS

(71) Applicant: ZHEJIANG UNIVERSITY OF SCIENCE & TECHNOLOGY, Hangzhou (CN)

(72) Inventors: Wenjian XU, Hangzhou (CN); Dongpo GUO, Hangzhou (CN); Yu LI, Hangzhou (CN); Qizhi QIAN, Hangzhou (CN); Lijuan ZHANG, Hangzhou (CN); Lei ZHANG, Hangzhou (CN)

(73) Assignee: ZHEJIANG UNIVERSITY OF SCIENCE & TECHNOLOGY, Hangzhou (CN)

(21) Appl. No.: 19/536,309

(22) Filed: Feb. 11, 2026

(30) Foreign Application Priority Data
May 19, 2025 (CN) 202510641967.6

(51) Int. Cl. G06F 3/0482; G06N 20/00; G06Q 30/0601

(52) U.S. Cl. CPC G06F 3/0482; G06N 20/00; G06Q 30/0631

(57) ABSTRACT

Provided is a spatiotemporal data augmentation method for a recommendation system. The method explicitly summarizes spatiotemporal features of users and items and uses a large model as an encoder to unify embeddings in a single vector space; then uses a linear layer to align feature dimensions for fusion into a recommendation model, thereby solving the problem of insufficient feature fusion. The method leverages the large model to comprehend an interaction history and a candidate set of a user, infers preferences of the user and generates positive and negative sample pairs, and merges the generated sample set with an original sample set to form a final training set. Benefiting from the excellent reasoning and natural language understanding capabilities of the large model, the method achieves both expansion of the training sample set and mitigation of a noise issue.

### CROSS-REFERENCE TO RELATED APPLICATIONS

This application claims priority to the Chinese Patent Application No. 202510641967.6, filed on May 19, 2025, the contents of which are hereby incorporated by reference.

### TECHNICAL FIELD

The present disclosure relates to the field of information recommendation technology, and in particular, to spatiotemporal data augmentation methods for recommendation systems.

### BACKGROUND

Spatiotemporal recommendation systems significantly expand application boundaries of recommendation systems by fusing users' geographical locations and temporal information. Such systems not only consider historical behaviors and preferences of users but also employ various techniques to process temporal and spatial features.

To improve recommendation performance, considerable efforts have been made in existing work. Some traditional recommendation models seek to enhance performance by modeling interaction relationships between users and items. These models primarily rely on collaborative filtering techniques, which offer limited capability to process complex features and fail to leverage spatiotemporal attributes to aid recommendations. Moreover, these models face a challenge of insufficient supervisory signals (feedback data). Other models utilize spatiotemporal sequence information to assist in modeling. However, these models do not explicitly encode preferences of users and features of items and effectively integrate the preferences and features into a model, leading to a shallow understanding of user preferences and item features.

Data augmentation generates new training samples by applying various transformations to original data. Regarding spatiotemporal data, most prior research has employed traditional algorithms for augmentation. While this prior research has achieved some progress, it still fails to address inherent problems of recommendation systems. Specifically, the prior research does not directly enhance interactions between users and items, and an issue of low-quality user feedback data persists.

In recent years, large models have experienced rapid development and achieved remarkable success in numerous tasks and fields. Initially, large models were developed as pre-trained language foundation models to tackle various natural language processing tasks. However, over time, the parameter count of large models has grown exponentially, enabling them to exhibit powerful natural language understanding capabilities. These large models can learn complex semantics and knowledge representations from large-scale text corpora and accomplish a wide range of reasoning tasks. Some recent studies have attempted to leverage large models to assist in recommendation systems. Nevertheless, these studies only augment ordinary features and fail to consider spatiotemporal features.

Based on shortcomings of existing research, current recommendation systems primarily face two challenges. The first challenge is a lack of explicitly summarizing spatiotemporal features and encoding and fusing the spatiotemporal features into a recommendation model. Collection of user location information and behavior time is constrained by privacy protection, potentially resulting in insufficient data to mine spatiotemporal preferences of users, summarize the spatiotemporal preferences in textual form, and ultimately encode and fuse the summarized preferences into a recommendation system. The second challenge is low quality of user feedback data, including issues of data sparsity and noise. In terms of data sparsity, due to temporal and spatial constraints, users often interact with only a small fraction of items in a system, leading to relatively sparse feedback data. For example, in a restaurant recommendation system, constrained by work schedules, users may only be active during holidays. Regarding the noise problem, users may interact with items influenced by trends or social circles, which does not represent true preferences of the users. For example, a user might choose a restaurant due to a high rating of the restaurant on a recommendation system but dislike the restaurant.

In summary, current research on spatiotemporal recommendation systems suffers from inadequate feature fusion and low-quality user feedback data. Therefore, there is an urgent need for a solution that addresses the above problems and enhances the performance of spatiotemporal recommendation models.

### SUMMARY

In view of the deficiencies in the prior art, the present disclosure proposes a spatiotemporal augmentation recommendation method based on a large model. The method leverages the excellent natural language processing and reasoning capabilities of the large model to summarize features of users and items via the large model, and encodes and fuses the summarized features into a recommendation system, thereby solving the problem of insufficient feature fusion in a spatiotemporal recommendation system.

Furthermore, the large model may be used to generate positive and negative sample pairs for each user, expanding the number of training samples and mitigating noise caused by random sampling in Bayesian Personalized Ranking (BPR) algorithms, thereby addressing the problem of low-quality user feedback data.

One or more embodiments of the present disclosure provide a spatiotemporal data augmentation method for a recommendation system. The spatiotemporal data augmentation method includes:
step 1, obtaining an augmented item temporal feature by augmenting a temporal feature of an item using a large model;
step 2, obtaining augmented user features by summarizing an ordinary feature, a temporal feature, and a spatial feature of a user based on an interaction history of the user using reasoning capability of the large model;
step 3, using the large model to comprehend the interaction history of the user and a candidate item set, and reasoning out items that the user is interested in and items that the user is not interested in as positive and negative sample pairs to expand a training sample set;
step 4, generating a high-dimensional vector by inputting the augmented item temporal feature, an original item ordinary feature and an original item spatial feature in a dataset, and the augmented user features into an encoding layer, and performing dimensionality reduction on the high-dimensional vector using a linear layer;
step 5, obtaining a comprehensive representation by inputting a feature vector after the dimensionality reduction and an identifier (id) embedding vector generated by a base recommendation model into a feature fusion layer for weighted fusion;
step 6, training a recommendation model using a BPR loss function, the training including: obtaining a first loss function by inputting the comprehensive representation into the BPR loss function without sample pruning, and merging augmented samples with an original training set to form a final training set;
step 7, obtaining a second loss function by inputting temporal features and spatial features from item features and user features after the dimensionality reduction into a BPR layer with pruning configured to apply a sample pruning strategy; and
step 8, optimizing the training of the recommendation model using a total loss function obtained by fusing the first loss function and the second loss function according to a preset weight.

The present disclosure also provides a recommendation system integrating the aforementioned spatiotemporal data augmentation method.

Compared with the prior art, some embodiments of the present disclosure include, but are not limited to, at least the following beneficial effects.
1. The present disclosure uses a large model to augment spatiotemporal data and applies it to a recommendation system. Compared with traditional spatiotemporal recommendation methods, the present disclosure explicitly summarizes spatiotemporal features of users and items, and uses the large model as an encoding layer to unify embedding in a single vector space. A linear layer is then used to align feature dimensions for fusion into the recommendation model, solving the problem of insufficient feature fusion.
2. Sparse and noisy user feedback is an inherent problem in recommendation systems. The present disclosure leverages the large model to comprehend a user's interaction history and candidate set, infers the user's preferences to generate positive and negative sample pairs, and merges the generated sample set with the original sample set as the final training set. Benefiting from the excellent reasoning and natural language understanding capabilities of the large model, this approach both expands the training sample set and mitigates the noise problem.
3. To emphasize relevant supervisory signals and prevent incorrect gradient descent, the present disclosure adopts a pruning strategy. Spatiotemporal features are used for sample pruning to remove a portion of easily distinguishable training sample pairs, making the optimization more stable and effective.
4. The spatiotemporal data augmentation method proposed in the present disclosure is pluggable and can be integrated into various recommendation models, thereby enhancing their recommendation effectiveness.

### BRIEF DESCRIPTION OF THE DRAWINGS

The present disclosure will be further illustrated by way of exemplary embodiments, which will be described in detail through the accompanying drawings.

FIG. 1 is a schematic diagram illustrating an offline stage framework of a spatiotemporal data augmentation process for a recommendation system according to some embodiments of the present disclosure;

FIG. 2 is a schematic diagram illustrating an online stage framework of a spatiotemporal data augmentation process for a recommendation system according to some embodiments of the present disclosure;

FIG. 3 is a schematic diagram illustrating a structure of a BPR layer with pruning according to some embodiments of the present disclosure.

FIG. 4 is a schematic diagram illustrating three prompt templates according to some embodiments of the present disclosure; and

FIG. 5 is a schematic diagram illustrating an exemplary process for drawing graphical interface elements of items according to some embodiments of the present disclosure.

### DETAILED DESCRIPTION

In order to illustrate the technical solutions of the embodiments of the present disclosure more clearly, the accompanying drawings required for describing the embodiments are briefly introduced below. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It will be understood that the term “system,” “device,” “unit,” and/or “module” used herein are one method to distinguish different components, elements, parts, sections or assemblies of different levels in ascending order. However, the terms may be displaced by another expression if they achieve the same purpose.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in the present disclosure, specify the presence of stated operations and/or elements, but do not preclude the presence or addition of one or more other operations and/or elements thereof.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

The overall concept of the present disclosure may be divided into two stages: an offline stage of augmenting data using a large model and an online stage of training a recommendation model using augmented data. The offline stage may be further divided into three substages: item augmentation, user augmentation, and user-item augmentation. In the item augmentation substage, the large model is used to transform temporal features of items. In the user augmentation substage, the large model infers user preference information. In the user-item augmentation substage, the large model processes a user's interaction history and candidate set to generate positive and negative sample pairs. In the online stage, augmented features are fused into the recommendation model, and these text features are encoded and undergo dimensionality reduction. Finally, the present disclosure uses a BPR loss function to optimize the recommendation model and uses spatiotemporal features for sample pruning.

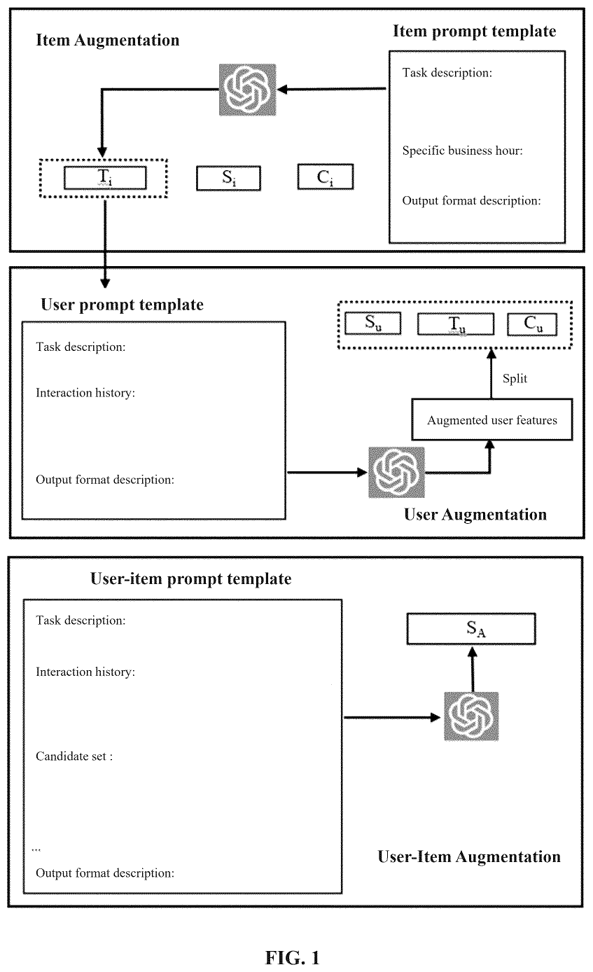

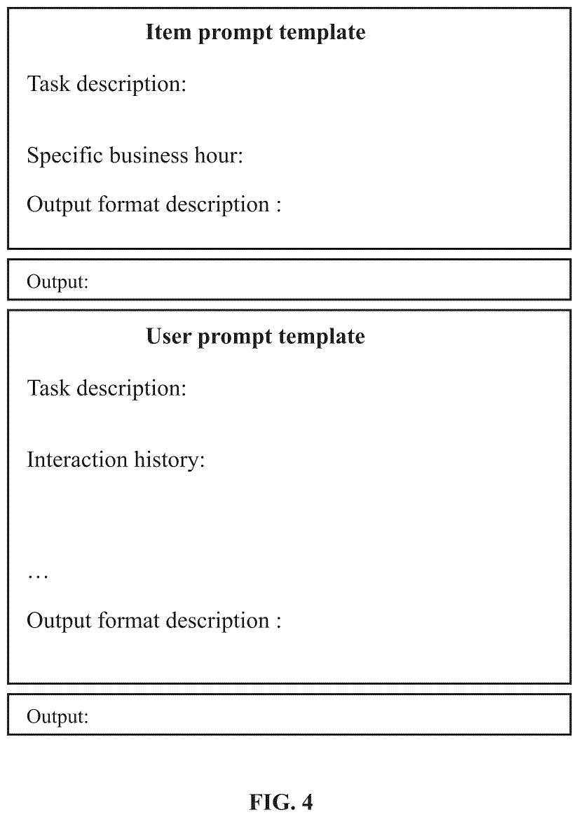

One or more embodiments of the present disclosure provide a spatiotemporal data augmentation method based on a large model. The method may be applied to a recommendation system, that is, the method is a spatiotemporal data augmentation method for a recommendation system. The spatiotemporal data augmentation method for a recommendation system applies a spatiotemporal augmentation recommendation technique based on a large model. FIG. 1 is a schematic diagram illustrating an offline stage framework of a spatiotemporal data augmentation process for a recommendation system according to some embodiments of the present disclosure. FIG. 4 is a schematic diagram illustrating three prompt templates according to some embodiments of the present disclosure.

In some embodiments, the spatiotemporal data augmentation method for a recommendation system may be executed by a processor. The processor refers to a device or a component for processing data and generating instructions. For example, the processor may be a Central Processing Unit (CPU), a Graphics Processing Unit (GPU), or any combination thereof.

In some embodiments, the spatiotemporal data augmentation method for a recommendation system may include the following steps.

Step 1, obtaining an augmented item temporal feature by augmenting a temporal feature of an item using a large model.

The large model refers to a Large Language Model (LLM) used for data augmentation. In some embodiments, the large model may be a pre-trained general-purpose model (e.g., GPT-4, ChatGLM, or Llama). The item refers to an entity in a recommendation system that interacts with users and has describable features. For example, the item includes a merchant, a product, or the like.

The temporal feature of the item refers to a feature used to describe an attribute of the item related to the time dimension. For example, when the item is a merchant, the corresponding temporal feature may be a specific business hour of the merchant. As another example, when the item is a product, the corresponding temporal feature may be a validity period of the product. One or more embodiments of the present disclosure take the merchant as an example to detail the spatiotemporal data augmentation method for a recommendation system.

The augmentation refers to a process of transforming an original temporal feature of the item into a coarse-grained temporal feature (i.e., the augmented item temporal feature). The augmented item temporal feature refers to a temporal feature output after processing by the large model and may be represented in text form. For example, if the temporal feature of the item is “specific business hours of the restaurant are Monday to Sunday: 14:00-24:00”, the augmented item temporal feature obtained after augmentation may be “afternoon and evening.”

In some embodiments, the processor may concatenate the specific business hour of the merchant (item) with an item prompt template, input a concatenated prompt into the large model to generate the augmented item temporal feature, and replace a temporal feature corresponding to the item in an original dataset with the augmented item temporal feature.

The item prompt template may be a predefined structured text framework. As shown in FIGS. 1 and 4, the item prompt template may include three parts: a task description, the specific business hour, and an output format description. The original dataset refers to a dataset storing merchant features (item features), which may be constructed based on historically accumulated merchant features in local storage or cloud storage. The concatenated prompt refers to a prompt text obtained by filling the corresponding template with the features. In step 1, the concatenated prompt may be obtained by filling the specific business hour of the item into the item prompt template. In some embodiments, the merchant features may be divided into an ordinary feature Cᵢ, a spatial feature Sᵢ, and the temporal feature Tᵢ. The ordinary feature refers to a static feature describing an attribute or category of an item. For example, the ordinary feature may include an inherent business type (e.g., a restaurant or a bar), a food category (e.g., Mexican food or dessert), a consumption scenario (e.g., nightlife). The spatial feature refers to information describing a location of the item. For example, the spatial feature may include a geographical location (e.g., a city), a spatial accessibility (e.g., near a subway line), or an area label (e.g., a business district). The features exist in the original dataset and are stored using a nested dictionary items. Keys of the first layer are the three aforementioned features, and the second layer stores the mapping between a merchant id and text features. The text features refer to specific text of the ordinary feature, spatial feature, and temporal feature.

In some embodiments, the processor may concatenate the specific business hour of the merchant with the item prompt template, then input the concatenated prompt into the LLM to obtain the augmented temporal feature Tᵢ. The augmented temporal feature Tᵢ is represented by the following formula:

$${T}_{i} = LLM ( {P}_{i} ) ,$$

where Pᵢ denotes the item prompt template, Tᵢ denotes the temporal feature in text form.

Merely by way of example, the task description in the item prompt template is “Please generate the text business hour of the restaurant based on its specific business hour. The corresponding relationships are: morning corresponds to 5:00-11:00 . . . ”, the specific business hour is “Monday: 16:45-21:30, Tuesday: 17:00-22:00 . . . ”, and the output format description is “Each text time is output at most once, separated by ‘,’”. Inputting the concatenated prompt into the large model yields the augmented temporal feature Tᵢ as “afternoon, evening”.

Since the merchant business hour is overly specific and fine-grained, which may lead to large errors in the user temporal feature inferred by the large model and difficulty in capturing user-merchant collaborative signals, the processor may further use the augmented item temporal feature Tᵢ to replace the temporal feature of the item in the original dataset corresponding to the dictionary items. In some embodiments, the processor may input the ordinary feature of the item, the spatial feature of the item, and the augmented item temporal feature into an encoding layer for further processing. More descriptions regarding the further processing may be found in step 4 and the related descriptions thereof.

Transforming fine-grained business hours into semantic temporal features solves the problem that original data is too fine-grained to be directly used for recommendation model modeling.

Step 2, obtaining augmented user features by summarizing an ordinary feature, a temporal feature, and a spatial feature of a user based on an interaction history of the user using reasoning capability of the large model.

The interaction history refers to historical interaction data between the user and the items. For example, the interaction history may include an interaction type, an interaction duration, and an interaction timestamp. The interaction type refers to an operation performed by the user on the item. The interaction type may include clicking, browsing, favoriting, adding to cart, rating, or liking. The interaction timestamp refers to a time point when the historical interaction occurred. The ordinary feature of the user refers to category information statistically derived from the interaction history of the user, which is typically reflected as the ordinary feature (e.g., a category) of the item. The temporal feature of the user refers to temporal information of the interactions of the user with the item. The spatial feature of the user refers to a location where the user interacted with the item.

The augmented user features refer to features obtained by processing with the large model. The augmented user features may include an augmented ordinary feature, an augmented temporal feature, and an augmented spatial feature of the user. The augmented user features may reflect the preference degree of the user for items. For example, the augmented ordinary feature may be the item categories the user likes. As another example, when the item category the user likes is a restaurant, the augmented temporal feature may be the dining time the user prefers, and the augmented spatial feature may be the dining location the user prefers.

In some embodiments, the processor may replace the specific business hour of each merchant (item) in the interaction history of the user with the augmented item temporal feature from step 1, then concatenate the interaction history after replacement with a user prompt template, and input a concatenated prompt into the large model to generate the augmented ordinary feature, the augmented temporal feature, and the augmented spatial feature.

The user prompt template may be a predefined structured text framework. As shown in FIG. 1 and FIG. 4, the user prompt template includes three parts: a task description, the user interaction history, and an output format description.

The concatenated prompt refers to the prompt text obtained by filling the corresponding template with the features. In step 2, the concatenated prompt may be obtained by filling the interaction history after replacement into the user prompt template.

Specifically, the processor may input the concatenated prompt into the large model to obtain the augmented user features, then call a Python split function to segment the augmented user features, obtaining for each user the augmented ordinary feature Cᵤ, the augmented temporal feature Tᵤ, and the augmented spatial feature Sᵤ. A nested dictionary users is used for storage, where the keys of the first layer are the three aforementioned features, and the second layer stores the mapping between the user id and text features. The formula is represented as follows:

cᵤ,sᵤ,Tᵤ=Split(LLM(Pᵤ)),

where Pᵤ is the user prompt template, and Cᵤ, Sᵤ, Tᵤ are the augmented ordinary feature, augmented temporal feature, and augmented spatial feature in text form, respectively. More descriptions regarding the text features may be found in step 1 and related descriptions thereof.

Merely by way of example, the task description in the user prompt template is “Generate a user profile based on the interaction history of the user. Information for each restaurant includes name, category, address, business hours.”, the interaction history is “[2223] Name: Casa, Category: Mexican, Dessert . . . , Address: Dunedin, Business Hours: noon, afternoon, evening. [1717] Name: The Row, Category: Nightlife, Bar . . . , Address: Dunedin, Business Hours: afternoon, evening”, and the output format description is “Please output the following user information: liked categories, liked address, liked dining time, separated by ‘::’”. Inputting the concatenated prompt into the large model yields the augmented user features as “Dessert, Bar, Nightlife:: Dunedin:: afternoon, evening”. Then, segmenting the augmented user features yields the augmented spatial feature Sᵤ as “Dunedin”, the augmented temporal feature Tᵤ as “afternoon, evening”, and the augmented ordinary feature Cᵤ “Dessert, Bar, Nightlife”.

In some embodiments, the processor inputs the augmented ordinary feature, the augmented temporal feature, and the augmented spatial feature of the user into the encoding layer for further processing. More descriptions regarding the further processing may be found in step 4 and related descriptions thereof.

Transforming user implicit behavior logs into explicit semantic profiles (preferences such as category, time, or space) provides a high-quality, strong feature foundation for subsequent recommendation model modeling.

In some embodiments, the step 2 further includes: generating an interest state sequence of the user based on a historical behavior sequence of the user; and generating an interest change feature of the user based on the historical behavior sequence and the interest state sequence through the large model.

The historical behavior sequence refers to a sequence obtained by arranging a plurality of interaction histories in a historical interaction record of the user according to the chronological order of interaction timestamps. One interaction history corresponds to one interaction between the user and a specific item. The historical interaction record refers to a record documenting a plurality of interaction histories of a user. The historical interaction record includes a user identifier (e.g., user id), a plurality of item identifiers (e.g., merchant ids), interaction types corresponding to the plurality of items, interaction durations, and interaction timestamps. In some embodiments, the processor may obtain the historical behavior sequence of the user based on historical data.

The interest state sequence refers to a sequence composed of a plurality of interest state segments. The interest state segment includes interest features of the user within a specific time period. The specific time period is a relatively short duration, such as 1 week, 2 weeks, etc. The interest features include a plurality of items and a degree of interest in each of the plurality of items. The degree of interest may be represented by a numerical value from 1 to 10, where a higher value indicates a greater degree of interest.

In some embodiments, for each interaction history in the historical behavior sequence, the processor counts corresponding historical items to obtain an item set including a plurality of historical items; divides the historical behavior sequence into a plurality of subsequences according to a duration of the specific time period; for each historical item, counts the interaction frequency and interaction duration of the user with that item in each subsequence, performs normalization on the interaction frequencies and interaction durations across all subsequences, and performs a weighted summation to obtain the degree of interest corresponding to the historical item for the specific time period. Repeating the above steps for each historical item yields the respective degrees of interest for the plurality of historical items across various specific time periods, thereby obtaining the interest state sequence.

The interest change feature refers to a feature characterizing changes in attention of a user to different item categories. The interest change feature includes an interest category distribution across different time periods, an interest change magnitude between adjacent time periods, and a temporal weight. The interest category distribution refers to a distribution of attention of the user across different item categories, e.g., [Technology: 0.8, Entertainment: 0.1, Food: 0.1]. The interest change magnitude refers to a magnitude of change in attention of the user to each item category between adjacent time periods, e.g., [Technology: +0.2, Entertainment: −0.1, Food: −0.1]. The temporal weight refers to a time-sensitive weight characterizing a degree of recent interest shift of the user. The time-sensitive characteristic indicates that the temporal weight is capable of being dynamically adjusted over time. The temporal weight may include a global adjustment factor and a temporal weight sequence. The global adjustment factor may be a value in a range of 0 to 1, indicating the degree of interest shift of the user. A larger global adjustment factor indicates a greater degree of interest shift of the user. The temporal weight sequence includes weight values for different time periods, and the weight values of the different time periods collectively characterize a time-varying temporal weight. When the degree of interest shift of the user in the most recent time period (e.g., the past week) is relatively large (e.g., the global adjustment factor exceeds 0.5), which indicates that there is a significant change in the item categories of interest to the user recently, and the item categories in the most recent time period better reflect current preferences of the user. Therefore, the weight for the most recent time period may be set to a larger value, while weights for earlier time periods are set to smaller values, thereby constructing a temporal weight sequence with a numerical surge in the recent period. When the degree of interest shift of the user in the most recent time period (e.g., the past week) is relatively small (for example, the global adjustment factor is less than 0.5), it indicates that the item categories of interest to the user are relatively stable, and the item categories in historical time periods may all reflect current preferences of the user. Therefore, the weight for each time period may be set to the same value, thereby constructing a stable temporal weight sequence.

In some embodiments, the processor may input the interest state sequence into the large model along with a preset prompt to obtain the interest change feature. The preset prompt may be “Based on the historical behavior sequence of the user and the interest state sequence divided by time windows, map specific interaction items to macro interest categories, and accordingly determine the interest category distribution of the user for the current stage; by comparing distribution differences between adjacent time windows, quantify the interest change magnitude corresponding to each category; finally, based on the intensity of interest evolution, assess whether the user has undergone an interest shift, and generate a time weight parameter including a global adjustment factor and a temporal weight sequence.” The preset prompt may be set by a person skilled in the art based on actual requirements. More descriptions regarding the large model may be found in step 1 and related descriptions thereof.

By analyzing the temporal characteristics of user behavior, the dynamic evolution of user interests over time can be perceived and adapted to, thereby improving the accuracy of predicting recent preferences.

Step 3, using the large model to comprehend the interaction history of the user and a candidate item set, and reasoning out items that the user is interested in and items that the user is not interested in as positive and negative sample pairs to expand a training sample set.

The candidate item set refers to a set of candidate items used for screening items the user is interested in and not interested in. The candidate item set may include ordinary features, temporal features, and spatial features of the candidate items. The candidate item set is obtained by screening the entire item set using a base recommendation model. The training sample set refers to a set of samples used for training the recommendation model. More descriptions regarding training the recommendation model may be found may be found later in the present disclosure.

In some embodiments, the processor may perform the following operations: concatenating the interaction history of the user and the candidate item set with a user-item prompt template; scoring all items using the base recommendation model and ranking the items in a descending order, and selecting top 5 ranked items as a positive sample candidate set and selecting a plurality of items from top 10% ranked items as a negative sample candidate set; and inputting a concatenated prompt into the large model to generate the positive and negative sample pairs.

The user-item prompt template may be a predefined structured text framework. As shown in FIG. 1 and FIG. 4, the user-item prompt template includes a task description, the interaction history, the candidate item set, and an output format description.

The concatenated prompt refers to a prompt obtained by filling the corresponding template with features. In step 3, the concatenated prompt may be obtained by filling the interaction history after replacement and the candidate item set into the user-item prompt template.

The base recommendation model refers to a pre-trained foundational model. In some embodiments, the base recommendation model may be used to score all items. In some embodiments, the base recommendation model may be any viable recommendation model obtained by conventional algorithms, e.g., Neural Graph Collaborative Filtering (NGCF) or Graph Convolutional Matrix Completion (GCMC) based on collaborative filtering.

Due to token limit constraints when the large model processes input, in some embodiments, the processor may score all items using the base recommendation model and rank the items in the descending order. The processor may select a small portion of the items as the positive sample candidate set and the negative sample candidate set. For example, five items each are selected for the positive sample candidate set and the negative sample candidate set. In some embodiments, the processor may invoke a prediction inference function of the base recommendation model, then input user identifiers and a plurality of item identifiers corresponding to a plurality of interaction histories in the historical interaction record into the base recommendation model, and obtain predicted scores output for the plurality of items. More descriptions regarding the historical interaction record, user identifiers, and the plurality of item identifiers may be found in step 2 and related descriptions thereof.

In some embodiments, the base recommendation model may also implement other functions (e.g., an embedding lookup function) based on internal modules. More descriptions regarding additional functions of the base recommendation model may be found in step 5 and related descriptions thereof.

When selecting the negative sample candidate set, on one hand, to avoid becoming positive samples, the ranking of negative sample candidates should not be too high. On the other hand, to stimulate and enhance the effect of the recommendation model, these negative sample candidates should have a certain relevance to the positive samples, so their ranking should also not be too low. It has been shown through a plurality of experiments that selecting items from the top 10% ranked items as the negative sample candidate set yields optimal results.

Therefore, in some embodiment, the processor selects the top five ranked items as the positive sample candidate set, and selects a plurality of items ranked within the top 10% but not among the top five as the negative sample candidate set.

In some embodiments, the processor may input the concatenated prompt into the large model to output the positive and negative sample pair <p, n>. The positive and negative sample pair <p, n> is represented by the following formula:

$$< p , n >= LLM ( {P}_{ui} ) ,$$

where Pᵤᵢ denotes the user-item prompt template, and p and n denote a positive sample and a negative sample generated by the large model, respectively.

Merely by way of example, the task description in the user-item prompt template is “Recommend restaurants to the user based on the interaction history of the user. Information for each restaurant includes name, category, address, business hours.”, the interaction history is “[2223] Name: Casa, Category: Mexican, Dessert . . . , Address: Dunedin, Business Hours: noon, afternoon, evening; [1717] Name: The Row, Category: Nightlife, Bar . . . , Address: Dunedin, Business Hours: afternoon, evening”, the candidate set is “[4714] Name: Spice 28, Category: Brunch, Thai . . . , Address: Brandon, Business Hours: morning, noon; [3568] Name: The Borough Brewhouse, Category: Brewpub, Nightlife . . . , Address: Dunedin, Business Hours: afternoon, evening, night”, and the output format description is “Output the index of the favorite and least favorite restaurant of the user, separated by ‘::’”. The positive and negative sample pair “3568::7414” may be obtained by inputting the concatenated prompt into the large model.

The positive and negative sample pairs output by the large model are also referred to as augmented positive and negative sample pairs. In some embodiments, the processor may construct a set of augmented positive and negative sample pairs corresponding to all users to obtain an implicit feedback set S_{A}. The implicit feedback set S_{A} consists of paired training triples <u, p, n>, where u represents a specific user. In some embodiments, the processor may merge S_{A} with an original training set S at a certain ratio to form a final training set. More descriptions regarding merging S_{A} with the original training set S at a certain ratio to form the final training set may be found later in the present disclosure.

Since BPR random sampling can lead to false positive samples (noise) and false negative samples (non-interaction) problems, using the large model to comprehend the interaction history and candidate item set of the user and reasoning out items that the user is interested in and items that the user is not interested in as positive and negative sample pairs can achieve the objectives of expanding the training sample set and reducing noise, resulting in more reasonable and higher-quality positive and negative sample pair output.

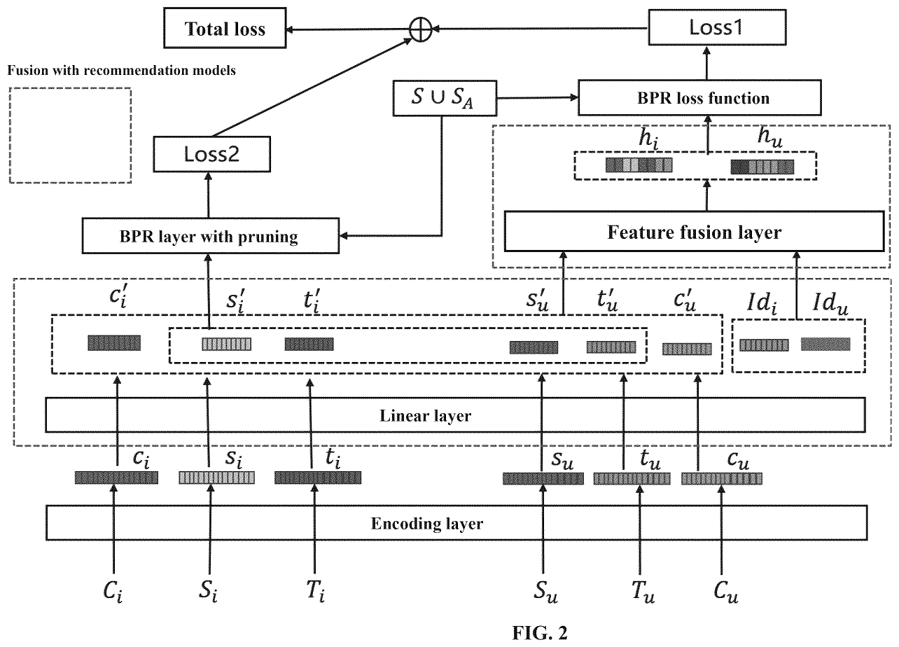

FIG. 2 is a schematic diagram illustrating an online stage framework of a spatiotemporal data augmentation process for a recommendation system according to some embodiments of the present disclosure. Steps 4 to 8 are described below with reference to FIG. 2.

Step 4, generating a high-dimensional vector by inputting the augmented item temporal feature, an original item ordinary feature and an original item spatial feature in a dataset, and the augmented user features into an encoding layer, and performing dimensionality reduction on the high-dimensional vector using a linear layer.

In some embodiments, the processor may encode augmented text features into the high-dimensional vectors using the large model as the encoding layer; and perform the dimensionality reduction on the high-dimensional vectors using the linear layer with dropout to obtain the feature vector after the dimensionality reduction.

The augmented text features refer to the augmented item temporal feature and the augmented user features output by the large model, both of which are in text form. To fuse with traditional recommendation models, the text features need to be encoded into vector representations. Since the large model has excellent context-aware capabilities and can learn rich semantic information, this embodiment uses the large model as the encoding layer. The encoding layer is represented by the following formula:

$${c}_{i} , {s}_{i} , {t}_{i} = Embedding ( {C}_{i} , {S}_{i} , {T}_{i} ) ,$$

$${c}_{u} , {s}_{u} , {t}_{u} = Embedding ( {C}_{u} , {S}_{u} , {T}_{u} ) ,$$

where Embedding represents the encoding layer, cᵢ, sᵢ, tᵢ denote the three types of encoded item features (i.e., the ordinary feature, spatial feature, and temporal feature of the item); cᵤ, sᵤ, tᵤ denote the three types of encoded user features (i.e., the ordinary feature, spatial feature, and temporal feature of the user). The encoded item features and the encoded user features are embedding vectors with a shape of 1*h, where 1 represents a single item or user, and h is a predefined hyperparameter representing the vector dimension, used to determine a size of a vector space for encoding semantic information.

Since the vectors encoded by the large model have excessively high dimensions and cannot be directly fused with the recommendation model, the processor employs the linear layer with dropout for dimensionality reduction, capturing key information while reducing the risk of overfitting. The linear layer is represented by the following formula:

$${c}_{i}^{′} , {s}_{i}^{′} , {t}_{i}^{′} = Linear ( {c}_{i} , {s}_{i} , {t}_{i} ) ,$$

$${c}_{u}^{′} , {s}_{u}^{′} , {t}_{u}^{′} = Linear ( {c}_{u} , {s}_{u} , {t}_{u} ) ,$$

where Linear represents the linear layer,

$${c}_{i}^{′} , {s}_{i}^{′} , {t}_{i}^{′}$$

denotes the three types of the item features after the dimensionality reduction;

$${c}_{u}^{′} , {s}_{u}^{′} , {t}_{u}^{′}$$

denotes the three types of the user features after the dimensionality reduction. The item features after the dimensionality reduction and the user features after the dimensionality reduction are embedding vectors with a shape of 1*l, where 1 represents a single item or user, l is a predefined hyperparameter representing the vector dimension after dimensionality reduction, and l<<h.

Using the large model as the encoding layer to encode high-dimensional vectors and performing dimensionality reduction using the linear layer with dropout ensures high-fidelity vectorization of augmented semantics, realizing efficient and stable adaptation of high-dimensional semantic features to downstream recommendation models.

Step 5, obtaining a comprehensive representation by inputting a feature vector after the dimensionality reduction and an identifier (id) embedding vector generated by a base recommendation model into a feature fusion layer for weighted fusion.

The id embedding vector refers to a real-number vector of a fixed dimension output by the base recommendation model, corresponding to each user identifier or item identifier.

In some embodiments, the id embedding vector is learned by the base recommendation model from historical interaction records using collaborative filtering mechanisms and multi-layer propagation mechanisms, and is stored in an embedding lookup table internal to the base recommendation model. In some embodiments, the processor may invoke an embedding lookup function of the base recommendation model, input a single user identifier or a single item identifier into the base recommendation model, query the embedding lookup table of the base recommendation model, determine the id embedding vector corresponding to the single user identifier or single item identifier (e.g., a id embedding vector Idᵤ of the user or an id embedding vector Idi of the item), and output the determined id embedding vector.

The feature fusion layer is used to integrate the feature vector after the dimensionality reduction and the id embedding vector. The feature fusion layer may be any known viable model structure, e.g., a Wide & Deep model.

The comprehensive representation refers to a unified vector representation for the user or the item output after weighted fusion of the feature vector after the dimensionality reduction and the id embedding vector by the feature fusion layer.

In some embodiments, the processor may input the three types of the item features after the dimensionality reduction, the three types of the user features after the dimensionality reduction, Idi, and Idᵤ together into the feature fusion layer, and obtain the comprehensive representation through weighted fusion. The specific calculation formulas are represented as follows:

$${h}_{i} = {Id}_{i} + {w}_{1} \cdot ( \frac{{s}_{i}^{′}}{{‖ {s}_{i}^{′} ‖}_{2}} + \frac{{t}_{i}^{′}}{{‖ {t}_{i}^{′} ‖}_{2}} ) + {w}_{2} \cdot \frac{{c}_{i}^{′}}{‖ {c}_{i}^{′} {‖}_{2}} ,$$

$${h}_{u} = {Id}_{u} + {w}_{1} \cdot ( \frac{{s}_{u}^{′}}{{‖ {s}_{u}^{′} ‖}_{2}} + \frac{{t}_{u}^{′}}{{‖ {t}_{u}^{′} ‖}_{2}} ) + {w}_{2} \cdot \frac{{c}_{u}^{′}}{‖ {c}_{u}^{′} {‖}_{2}} ,$$

where hᵢ and hᵤ denote the comprehensive item representation and comprehensive user representation, respectively. w₁ denotes a fusion weight for adjusting temporal features and spatial features, w₂ denotes a fusion weight for adjusting ordinary features, and ∥ ∥₂ denotes L2 normalization.

In some embodiments, the processor may perform L2 normalization on the feature vector after the dimensionality reduction prior to the weighted fusion to eliminate scale differences among different features.

Since the feature vectors after the dimensionality reduction may have different numerical scales, directly fusing the feature vectors after the dimensionality reduction would cause features with larger scales to dominate the gradients, affecting training stability and fusion effectiveness. Therefore, before the fusion, each feature vector after the dimensionality reduction needs to be individually subjected to L2 normalization. In some embodiments, for each feature vector after the dimensionality reduction, an L2 norm of the feature vector after the dimensionality reduction is calculated. Then each element in the feature vector after the dimensionality reduction is divided by this L2 norm to obtain a normalized vector. After the processing, all feature vectors after the dimensionality reduction are scaled to unit length, thereby eliminating scale differences.

Processing low-dimensional feature vectors through L2 normalization can improve numerical stability.

Step 6, training a recommendation model using a BPR loss function, wherein the training includes obtaining a first loss function by inputting the comprehensive representation into the BPR loss function without sample pruning, and merging augmented samples with an original training set to form a final training set.

The augmented samples refer to the positive and negative sample pairs output by the large model in step 3, i.e., the implicit feedback set S_{A}.

The original training set refers to a training sample set not augmented by the large model. The original training set S may be derived from historically accumulated user implicit feedback data. The user implicit feedback data refers to data that indirectly infers user preferences or interests by recording natural user behaviors during interactions with items (e.g., browsing or clicking). In some embodiments, the processor collects user implicit feedback data, constructs tuples consisting of user identifiers and item identifiers, thereby obtaining the original training set.

In some embodiments, the processor may input the comprehensive representation generated in step 5 into the BPR loss function without sample pruning, merge the augmented samples with the original training set at a preset ratio to form the final training set, and controls a proportion of the augmented samples in the final training set to prevent impact of noise on the training of the recommendation model. This process may generate the first loss function Loss1. The first loss function Loss1 is represented by the following formula:

$$Loss 1 = - {\sum }_{( u , p , n )}^{\vert S ⋃ {S}_{A} \vert} l n σ ( {\hat{y}}_{up} - {\hat{y}}_{un} ) + λ \cdot ‖ Θ ‖ {1}_{2}^{2} ,$$

where the training triples <u, p, n> are selected from the union S∪S_{A} of the implicit feedback set and the original training set. Since not all samples generated during the user-item augmentation substage are reliable interactions, and noise may still exist, using all of them for model training would impair performance. Therefore, some embodiment in the present disclosure needs to control the sample count of S_{A}. In some embodiments, merging the augmented samples with the original training set at a certain ratio may be achieved by using a parameter w₃ to control a fusion ratio of augmented sample pairs to the original training set, thereby generating the final training set.

Specifically, |S_{A}|=w₃*B, where |S_{A}| denotes a total count of the augmented samples; w₃ denotes an augmented sample fusion rate used to control the proportion of augmented samples in the final training set. w₃ may be preset based on experience. B denotes a batch size, i.e., a count of samples used for model training in each iteration. B may be preset. ŷᵤₚ=hᵤ*hₚ, ŷᵤₙ=hᵤ*hₙ, where, hᵤ denotes the comprehensive user representation, hₚ denotes the comprehensive item representation of the positive sample, hₙ denotes the comprehensive item representation of the negative sample, all of which may be calculated via step 5. ŷᵤₚ and ŷᵤₙ represent the user's scores for the positive sample and negative sample, respectively. σ(⋅) denotes the nonlinear sigmoid activation function. A denotes the L2 regularization coefficient and may be preset. To prevent overfitting, A is used in some embodiment in the present disclosure to control the L2 regularization strength

$${‖ Θ ‖}_{2}^{2} .$$

Merging the augmented samples with the original training set at a controllable ratio achieves safe and efficient fusion of knowledge inferred by the large model with historical real data. Such merging not only fully utilizes the knowledge enhancement capability of the large model to overcome data sparsity but also effectively suppresses potential noise in generated samples, thereby ensuring robustness and stability of model training.

In some embodiments, the step 6 further includes: determining, based on a historical interaction record and historical contextual information, a proportion of a plurality of augmented samples corresponding to the historical interaction record in the final training set.

The historical contextual information refers to contextual information corresponding to historical interactions. The contextual information includes a user interest phase during which each interaction occurred, a consistency degree between an item corresponding to an interaction and current interest features of the user, and whether an interaction is a passive interaction under high-exposure conditions. The user interest phase may include a fast-changing interest phase or a stable interest phase. The consistency degree between an interaction item and current interest features of the user refers to a similarity between a degree of interest in a historical item within a historical interaction and a degree of interest of the user in that item in a most recent interaction record. The exposure conditions refer to a display position and a display area when the item is presented to the user in a recommendation list. The display position closer to the top and a larger display area indicate higher exposure. For example, when the display position of the item is within top three positions, or the display area of the item occupies more than 60% of a full screen area, the interaction is considered to be under the high-exposure conditions.

In some embodiments, the contextual information may be obtained by analyzing existing business logs, historical interaction records, interest change features, or the like. For example, the processor may determine a time of an interaction occurrence based on the historical interaction record, and determine the user interest phase according to an interest change magnitude corresponding to that time; a larger interest change magnitude indicates faster-changing interests. As another example, the processor may determine a difference between a degree of interest in the historical item within the historical interaction and a degree of interest of the user in that item in the most recent interaction record, and use a reciprocal of the difference as the consistency degree between the interaction item and current interest features of the user. As yet another example, the processor may query business logs to obtain exposure conditions of an item in the recommendation list and determine whether the interaction belongs to high-exposure conditions.

More descriptions regarding the interest features, the historical interaction record, and the historical behavior sequence may be found above in the present disclosure.

In some embodiments, proportions of the plurality of augmented samples corresponding to the historical interaction record in the final training set may be the same. The proportion may be determined through cluster analysis based on the historical interaction record and the historical contextual information. The processor may perform clustering on objects to be clustered to obtain a plurality of clusters. The cluster containing a target vector is a target cluster. Labels corresponding to all cluster vectors in the target cluster are obtained, and an average value of the plurality of labels is determined as the proportion corresponding to the target vector.

The objects to be clustered refer to cluster vectors and the target vector. The cluster vectors refer to a plurality of historical interaction records and historical contextual information corresponding to the plurality of historical interaction records that have already been used as augmented samples to train the model. The target vector refers to the current historical interaction record and historical contextual information. The label of a cluster vector refers to the proportion actually used during the training process that can significantly improve recommendation accuracy (e.g., improvement by a preset margin such as 0.5%).

In some embodiments, the processor may determine, based on the historical contextual information and the historical interaction record, a confidence score for each historical interaction in the historical interaction record through a confidence assessment unit; determine a proportion range based on the historical interaction record; and determine the proportion based on the proportion range and the confidence score.

The confidence assessment unit refers to a logic module for calculating a probability that an interaction record reflects a true interest of the user. The confidence score may be a continuous value in a range of 0 to 1. The confidence score indicates a credibility that a specific interaction record aligns with a true interest of the user.

In some embodiments, for each historical interaction in the historical interaction record: the confidence assessment unit may preset a lookup table mapping interaction types to confidence levels; determine a corresponding confidence level as an initial confidence score by looking up the table based on an interaction type; determine a correction coefficient (e.g., a value in a range of 0 to 1) based on corresponding historical exposure conditions and a consistency degree in the historical contextual information via a preset rule table; and multiply the initial confidence score by a correction coefficient to obtain the confidence score. The preset rule table includes correspondences between a plurality of historical exposure conditions and consistency degrees with correction coefficients. Among historical exposure conditions, a more centered display position of the item and a larger display area correspond to a smaller correction coefficient; a higher consistency degree corresponds to a larger correction coefficient.

The proportion range is used to define boundaries for the final weight. For example, the proportion range may be [0.1, 0.5] or [1.0, 1.5].

In some embodiments, the processor may determine a corresponding proportion range for each historical interaction based on an interaction type of the historical interaction via a preset table. A logic for setting the preset table may be: for a click behavior, set the proportion range to [0.1, 0.5]; for a favorite behavior, set the proportion range to [0.5, 1.0]; and for a purchase behavior, set the proportion range to [1.0, 2.0].

In some embodiments, the processor may obtain the proportion through linear interpolation based on the proportion range and the confidence score. For example, for each historical interaction, the proportion of a corresponding augmented sample in the final training set=lower bound of the proportion range+confidence score*(upper bound of proportion range−lower bound of proportion range).

Determining weights by combining both the interaction type dimension and the confidence score dimension ensures differentiation in values of different behaviors while reflecting quality differences of individual data items.

In some embodiments, the step 6 further includes: performing constraint processing on the proportion.

The constraint processing refers to an operation of numerically adjusting an originally calculated proportion. In some embodiments, the constraint processing includes at least one of upper and lower bound constraint processing, proportional scaling processing, or smoothing processing. The upper and lower bound constraint processing refers to forcing the proportion to be a preset upper threshold when the proportion is greater than the preset upper threshold, or forcing the proportion to be a preset lower threshold when the proportion is less than the preset lower threshold. The proportional scaling processing refers to dividing a preset scaling constant by an average value of proportions of all augmented samples to obtain a scaling factor, and multiplying a proportion of each augmented sample by the scaling factor. The smoothing processing refers to applying smoothing to proportions of all augmented samples.

Performing numerical constraint processing and smoothing processing on training weights prevents model parameter oscillations caused by individual extreme weights, thereby ensuring stability during a model convergence process.

Reducing the training weight of low-confidence or noisy interaction samples diminishes interference from invalid data on model parameter updates, thereby enhancing stability of model training.

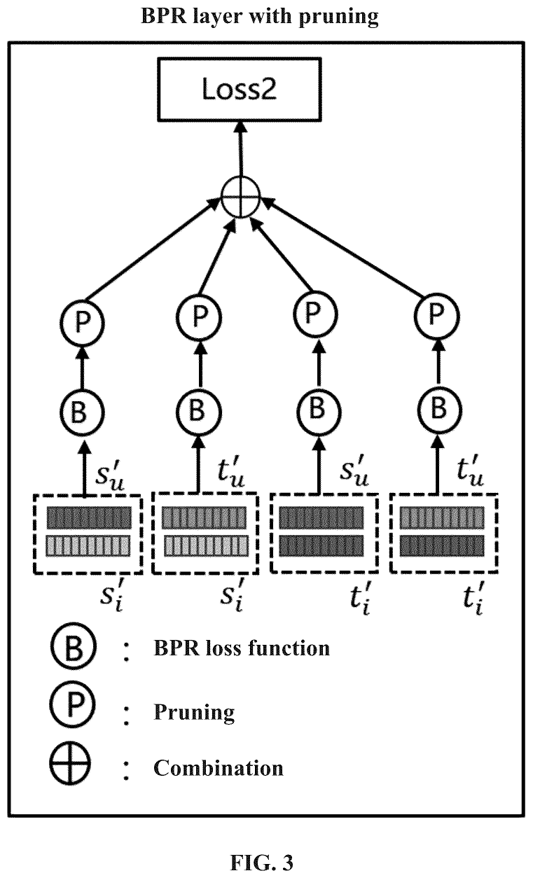

FIG. 3 is a schematic diagram illustrating a structure of a BPR layer with pruning according to some embodiments of the present disclosure. The spatiotemporal data augmentation method for a recommendation system further includes the following steps.

Step 7, obtaining a second loss function by inputting temporal features and spatial features from item features and user features after the dimensionality reduction into a BPR layer with pruning configured to apply a sample pruning strategy.

In some embodiments, the processor may perform the following operations: inputting the temporal features and the spatial features from the item features and the user features after the dimensionality reduction into the BPR layer with pruning; performing sample pruning to remove a portion of easily distinguishable training triples using the temporal features and the spatial features; obtaining the second loss function by processing four different combinations of the temporal features and the spatial features respectively through four BPR loss functions. The sample pruning strategy is applied after processing by each of the four BPR loss functions.

In some embodiments, to determine the second loss function Loss2, the processor may input the item temporal feature

$${t}_{i}^{′} ,$$

the item spatial feature

$${s}_{i}^{′} ,$$

the user temporal feature

$${t}_{u}^{′} ,$$

and the user spatial feature

$${s}_{u}^{′}$$

into the BPR layer with sample pruning. The BPR layer includes four BPR loss functions, which are respectively configured to receive four spatiotemporal feature combinations:

$${t}_{i}^{′} and {t}_{u}^{′} , {s}_{i}^{′} and {t}_{u}^{′} , {t}_{i}^{′} and {s}_{u}^{′} , and {s}_{i}^{′} and {s}_{u}^{′} .$$

To emphasize relevant supervisory signals, the temporal features and spatial features are used to perform sample pruning to remove a portion of easily distinguishable training triples, which may make optimization more stable and effective. The easily distinguishable training triples refer to triples with smaller losses. For example, the easily distinguishable training triples may be triples whose loss is less than a preset threshold. As another example, the easily distinguishable training triples may be the top M triples when losses are sorted in ascending order, where M may be preset. The calculation formula is represented as follows:

$${L}^{k} = - {\sum }_{( u , p , n )}^{M} Asc ( ln σ ( {\hat{y}}_{up}^{k} - {\hat{y}}_{un}^{k} ) ) + λ \cdot {‖ Θ ‖}_{2}^{2} ,$$

where L^{k} denotes the loss obtained from processing by each BPR loss function. The function Asc(⋅) sorts the loss of each training triple in ascending order and selects the top M items. M=(1−w₄)·|S ∪ S_{A}|, where w₄ denotes a pruning rate. When

$$k = 1 , {\hat{y}}_{up}^{1} = {t}_{i}^{′} * {t}_{u}^{′} ;$$

when k=2,

$${\hat{y}}_{up}^{2} = {s}_{i}^{′} * {t}_{u}^{′} ;$$

when k=3,

$${\hat{y}}_{up}^{3} = {t}_{i}^{′} * {s}_{u}^{′} ;$$

when k=4,

$${\hat{y}}_{up}^{4} = {s}_{i}^{′} * {s}_{u}^{′} .$$

Each BPR loss function determines the loss for one spatiotemporal combination. The Loss2 is obtained by summing the losses from the four BPR loss functions. The Loss2 is represented by the following formula:

$$Loss 2 = {\sum }_{k = 1}^{4} {L}^{k} .$$

Establishing four independent loss functions specifically for spatiotemporal features and performing sample pruning separately forces the model to focus on learning key matching patterns in the spatiotemporal dimension, avoids interference from simple samples, and achieves intensified supervision of spatiotemporal signals.

Step 8, optimizing the training of the recommendation model using a total loss function obtained by fusing the first loss function and the second loss function according to a preset weight.

In some embodiments, the processor may obtain the total loss function by fusing the first loss function obtained in step 6 and the second loss function obtained in step 7 according to the preset weight; and optimize the training of the recommendation model using the total loss function to improve performance of the recommendation system.

In some embodiments, the preset weight may be determined by a person skilled in the art based on experience. In some embodiments, the preset weight may be determined through hyperparameter tuning. For example, an optimal weight may be selected from a set of preset values via grid search on a validation set.

Determination of the total loss function is represented by the following formula:

$${L}_{total} = Loss 1 + {w}_{5} \cdot Loss 2 ,$$

where w₅ is used to control the proportion of Loss2 in Lₜₒₜₐₗ.

In some embodiments, the total loss function may be used to optimize the training of the recommendation model via a gradient descent algorithm. For example, in each training iteration, the gradient of the total loss function with respect to all parameters of the recommendation model may be determined, and the parameters may be updated in the opposite direction of the gradient.

In some embodiments, as shown in FIG. 2, a complete training process of the recommendation model is as follows: inputting the temporal features, the spatial features, and the ordinary features of the item and the user respectively into the encoding layer to obtain three types of encoded features for each; inputting the three types of encoded features into the linear layer to obtain the features after the dimensionality reduction; inputting the features after the dimensionality reduction and the id embedding vectors into the feature fusion layer to obtain output the comprehensive user representation and the comprehensive item representation; inputting the comprehensive user representation and comprehensive item representation into the BPR loss function without sample pruning to determine the first loss function; simultaneously, inputting the temporal features and the spatial features after the dimensionality reduction into the BPR layer with sample pruning to determine the second loss function; then fusing the first loss function and the second loss function according to the preset weight to obtain the total loss function; finally, using a gradient descent algorithm to perform backpropagation by the gradient of the total loss function and updating all trainable parameters of the model in one go. A trained recommendation model is obtained when model convergence conditions are satisfied. The model convergence conditions may be that the total loss stabilizes, maximum training epochs are reached, or the like.

The fusion of the two loss functions realizes a collaborative, balanced, and efficient training paradigm, thereby enhancing the performance of the recommendation system.

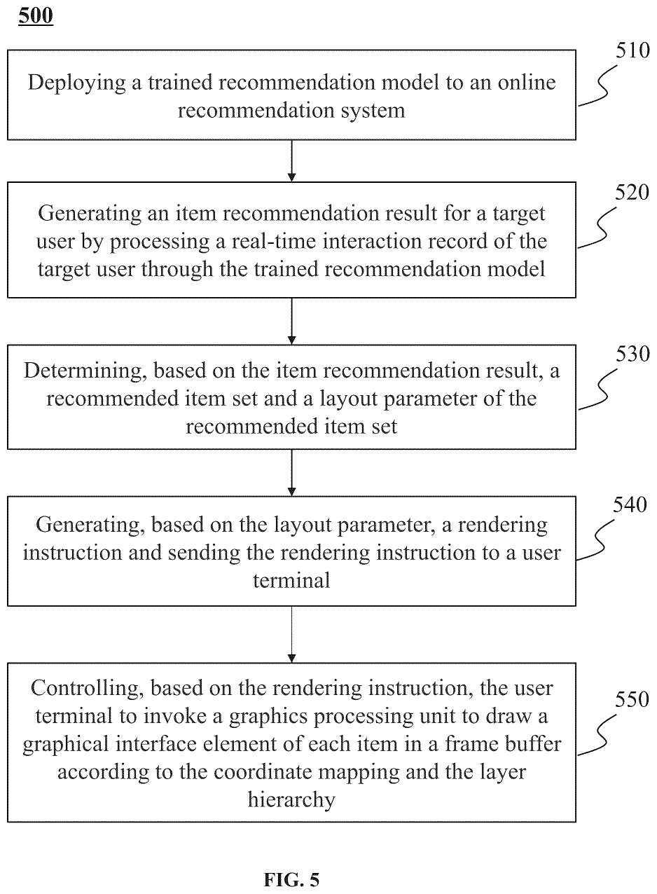

FIG. 5 is a schematic diagram illustrating an exemplary process for drawing graphical interface elements of items according to some embodiments of the present disclosure. As shown in FIG. 5, a process 500 may include the following steps. In some embodiments, the process 500 may be executed by a processor.

Step 510, deploying a trained recommendation model to an online recommendation system.

The online recommendation system refers to a computer system deployed in a production environment responsible for real-time processing of user requests and returning recommendation results. More descriptions regarding the trained recommendation model may be found in the related descriptions of model training above.

Step 520, generating an item recommendation result for a target user by processing a real-time interaction record of the target user through the trained recommendation model.

The real-time interaction record refers to a real-time interaction record of the user. In some embodiments, the real-time interaction record may be obtained based on the recommendation system collecting user behaviors in real time. The item recommendation result may include a plurality of recommended items and corresponding scores (e.g., values in a range of 0 to 1).

In some embodiments, the processor may input the real-time interaction record of the target user into the trained recommendation model to obtain the output item recommendation result.

Step 530, determining, based on the item recommendation result, a recommended item set and a layout parameter of the recommended item set.

The recommended item set refers to an item set displayed on a user terminal.

The layout parameter refers to layout parameters for displaying items on the user terminal. In some embodiments, the layout parameter may include a coordinate mapping and a layer hierarchy of each item in the recommended item set.

The coordinate mapping is used to define a specific rectangular area of a frame buffer in which the GPU should draw pixels of an item during a rasterization stage. For example, the coordinate mapping may include starting vertex coordinates of the item in a screen coordinate system (typically with a top-left corner of a screen as an origin), and width and height pixel values that the item occupies in screen space.

The layer hierarchy refers to a drawing order and a stacking relationship of each item or graphical element along a direction perpendicular to a screen (Z-axis) during two-dimensional screen rendering. The layer hierarchy determines a vertical positional relationship of overlapping elements when coordinates of a plurality of graphical elements overlap, during depth testing or pixel blending performed by the GPU.

The layer hierarchy may include: a Z-axis index and a hierarchical structure. A larger Z-axis value indicates closer proximity to a view of the user corresponding to a higher layer. The hierarchical structure includes: a background layer (Level 0) for container background and shading; a content layer (Level 1) for regular recommendation item cards; a floating layer (Level 2) for highlighted display of high-confidence items (e.g., special effects breaking a layout) and corner marks (e.g., “Hot” labels); and an overlay layer (Level 3) for guidance prompts and pop-up windows.

In some embodiments, the processor may sort the item recommendation result by score in descending order and take top N items as the recommended item set. A value of N may be preset based on experience.

In some embodiments, the processor may use a plurality of historical item recommendation results as feature vectors, and for each feature vector, select the historical layout parameter from the corresponding historical recommendation where the user either made the fewest manual adjustments to the item order or performed the fewest clicks (implying that the user could directly access content of interest) as the corresponding label, thereby constructing a first vector database. Then, the processor may designate a current item recommendation result as the target vector, find a feature vector with the highest similarity to the target vector in the first vector database, and designate the label corresponding to the feature vector as the layout parameter corresponding to the target vector.

Step 540, generating, based on the layout parameter, a rendering instruction and sending the rendering instruction to a user terminal.

The rendering instruction may include the coordinate mapping and the layer hierarchy of each item in the recommended item set.

Step 550, controlling, based on the rendering instruction, the user terminal to invoke a graphics processing unit to draw a graphical interface element of each item in a frame buffer according to the coordinate mapping and the layer hierarchy.

The frame buffer is a region for storing pixel data of one frame of an image. A graphical interface element refers to a visual basic unit constituting a graphical user interface, having specific appearance, interaction logic, and functionality.

In some embodiments, after receiving the rendering instruction, the user terminal bypasses a local layout computation engine and directly invokes the rasterization pipeline of the GPU to directly draw the graphical user interface elements corresponding to the recommended item set in the frame buffer according to the coordinate mapping and the layer hierarchy.

In some embodiments, the item recommendation result further includes a predicted interaction probability for the item.

The predicted interaction probability refers to a probability that the user will interact with the item.

In some embodiments, the processor may generate a preloading instruction based on the predicted interaction probability and send the preloading instruction to the user terminal; and control, based on the preloading instruction, the user terminal to perform hierarchical memory allocation for the item based on the memory priority.

The preloading instruction may include a memory priority of each item in the recommended item set. In some embodiments, the memory priority may be divided into a first priority, a second priority, and a third priority. The first priority indicates a very high probability. The second priority indicates a medium probability. The third priority indicates a low probability.

In some embodiments, the processor may preset a relationship lookup table between the predicted interaction probability and the memory priority. A higher predicted interaction probability corresponds to a higher memory priority. The processor may determine the corresponding memory priority by looking up the relationship lookup table based on the predicted interaction probability output by the trained recommendation model, thereby obtaining the preloading instruction.

In some embodiments, based on the preloading instruction, the processor may control the user terminal to perform hierarchical memory allocation for the item based on the memory priority. For example, a resource loader of the user terminal may receive the preloading instruction and execute a differentiated memory allocation strategy based on the memory priority.

For items with the first priority, the user terminal may perform preloading. Before each item enters a screen viewport, the user terminal may use idle I/O threads to decode a high-definition resource (e.g., images or first video frames) in advance and load the high-definition resources into heap memory. The user terminal may then perform memory locking, marking the resource as “non-recyclable” or placing the resource in an L1 cache pool to prevent the resource from being cleaned up by a Garbage Collection (GC) mechanism, thereby ensuring “zero-delay” rendering when a user scrolls to a corresponding position.

For items with the second priority, the user terminal may allocate a memory pool of a fixed size (e.g., 20% of total available memory or a fixed 50 MB) as a cache upper limit. While the memory pool is not full, the user terminal maintains strong references to resources of second-priority items, ensuring the resources are not automatically cleared by the GC, thereby guaranteeing smoothness when the user repeatedly scrolls up and down within a short time.

For items with the third priority, the user terminal may allocate only a minimal space in memory to store a placeholder image or a low-resolution thumbnail. Once the item slides out of the screen viewport, the user terminal immediately releases physical memory occupied by the item, thereby freeing up space for higher-priority items.

Mapping the predicted interaction probability from the recommendation model to the memory priority and controlling the terminal to perform hierarchical memory allocation achieves dynamic scheduling of hardware storage resources based on user interest intent, thereby optimizing terminal memory utilization while improving a loading response speed of high-probability recommendation content.

Some embodiments of the present disclosure achieve direct dynamic control of a recommendation algorithm over a pixel-level layout and render behavior of a physical display interface of the user terminal by converting recommendation results directly into rendering instructions containing the coordinate mapping and the layer hierarchy, and by driving a GPU of the terminal to perform frame buffer drawing.

One or more embodiments of the present disclosure further provide a recommendation system. The recommendation system includes at least one processor. The at least one processor may be configured to: obtain an augmented item temporal feature by augmenting a temporal feature of an item using a large model; obtain augmented user features by summarizing an ordinary feature, a temporal feature, and a spatial feature of a user based on an interaction history of the user using reasoning capability of the large model; use the large model to comprehend the interaction history of the user and a candidate item set, and reason out items that the user is interested in and items that the user is not interested in as positive and negative sample pairs to expand a training sample set; generate a high-dimensional vector by inputting the augmented item temporal feature, an original item ordinary feature and an original item spatial feature in a dataset, and the augmented user features into an encoding layer, and perform dimensionality reduction on the high-dimensional vector using a linear layer; obtain a comprehensive representation by inputting a feature vector after the dimensionality reduction and an id embedding vector generated by a base recommendation model into a feature fusion layer for weighted fusion; train a recommendation model using a BPR loss function, the training including that obtaining a first loss function by inputting the comprehensive representation into the BPR loss function without sample pruning, and merging augmented samples with an original training set to form a final training set; obtain a second loss function by inputting temporal features and spatial features from item features and user features after the dimensionality reduction into a BPR layer configured to apply a sample pruning strategy; optimize the training of the recommendation model using a total loss function obtained by fusing the first loss function and the second loss function according to a preset weight.

### Validation Example

A dataset used in the example is the Yelp dataset provided by Yelp Inc. Since the original dataset is too large, interaction data from the year 2018 is selected, merchants and users with fewer than 6 interactions are filtered out, and all user-merchant interactions are treated as implicit feedback.

Three commonly used recommendation algorithm evaluation metrics are employed: R@20, P@20, and N@20. The metric R@20 is defined as a proportion of practically relevant results among the top 20 recommendation results to all relevant results in a test set. The metric P@20 is defined as a proportion of practically relevant results among the top 20 recommendation results to a total of the top 20 recommendation results. The metric N@20 measures a ranking quality of the top 20 recommendation results.

As shown in Table 1, the performance improvement is achieved for two traditional recommendation models when combined with the spatiotemporal data augmentation method provided in some embodiments of the present disclosure.

TABLE 1
Overall Recommendation Performance Improvement of
Different Models Combined with This Embodiment:

| | GCMC | | | GCN | | |
|---|---|---|---|---|---|---|
| | Ori | +LLM | Imp. | Ori | +LLM | Imp. |
| R@20 | 0.967 | 0.1183 | 22.34% | 0.1003 | 0.1280 | 27.62% |
| N@20 | 0.0684 | 0.0842 | 23.10% | 0.0694 | 0.0891 | 28.39% |
| P@20 | 0.0103 | 0.0124 | 20.39% | 0.0106 | 0.0134 | 26.42% |

This embodiment improves the performance of both models, demonstrating the effectiveness and applicability of this embodiment. All metrics show improvements exceeding 20%, with GCN performing even better, showing improvements exceeding 25% for each metric.

Table 2 shows the impact of a ranking of a negative sample candidate set in the user-item augmentation substage on the performance of a recommendation model. The recommendation model is exemplified by GCMC* (GCMC enhanced using some embodiments of the present disclosure). The ranking refers to a ranking of the negative sample candidate set within an entire item set. For example, for a dataset having 9591 items, a ranking of 0.1% corresponds to selecting approximately 5 items around a 10-th position.

TABLE 2
Analysis of Negative Sample Candidate Set Ranking:

| Ranking | 0.1% | 3.0% | 10.0% | 40.0% | 99.9% |
|---|---|---|---|---|---|
| R@20 | 0.0928 | 0.1151 | 0.1183 | 0.1156 | 0.1111 |
| N@20 | 0.0695 | 0.0815 | 0.0842 | 0.0796 | 0.0777 |
| P@20 | 0.0099 | 0.0121 | 0.0124 | 0.0119 | 0.0116 |

As shown in Table 2, a ranking of 0.1% yields the worst results because positions of the corresponding negative sample candidate set are too high, which can cause bias in model learning. As the ranking increases, recommendation performance first increases and then decreases. A ranking of 10.0% achieves the best performance. An excessively high ranking leads to performance degradation because positions of the corresponding negative sample candidate set are too far back, resulting in low similarity to positive samples and thereby hindering model optimization.

The above has described the implementations of the present disclosure in detail with reference to the accompanying drawings. However, the present disclosure is not limited to the implementations described. For a person skilled in the art, various changes, modifications, substitutions, and variations may be made to these implementations, including components, without departing from the principle and spirit of the present disclosure, and such changes shall still fall within the protection scope of the present disclosure.

What is claimed is:

1. A spatiotemporal data augmentation method for a recommendation system, comprising:
step 1, obtaining an augmented item temporal feature by augmenting a temporal feature of an item using a large model;
step 2, obtaining augmented user features by summarizing an ordinary feature, a temporal feature, and a spatial feature of a user based on an interaction history of the user using reasoning capability of the large model;
step 3, using the large model to comprehend the interaction history of the user and a candidate item set, and reasoning out items that the user is interested in and items that the user is not interested in as positive and negative sample pairs to expand a training sample set;
step 4, generating a high-dimensional vector by inputting the augmented item temporal feature, an original item ordinary feature and an original item spatial feature in a dataset, and the augmented user features into an encoding layer, and performing dimensionality reduction on the high-dimensional vector using a linear layer;
step 5, obtaining a comprehensive representation by inputting a feature vector after the dimensionality reduction and an identifier (id) embedding vector generated by a base recommendation model into a feature fusion layer for weighted fusion;
step 6, training a recommendation model using a Bayesian Personalized Ranking (BPR) loss function, wherein the training includes obtaining a first loss function by inputting the comprehensive representation into the BPR loss function without sample pruning, and merging augmented samples with an original training set to form a final training set;
step 7, obtaining a second loss function by inputting temporal features and spatial features from item features and user features after the dimensionality reduction into a BPR layer with pruning configured to apply a sample pruning strategy; and
step 8, optimizing the training of the recommendation model using a total loss function obtained by fusing the first loss function and the second loss function according to a preset weight.

2. The spatiotemporal data augmentation method of claim 1, wherein the augmenting a temporal feature of an item in step 1 includes:
concatenating a specific business hour of the item with an item prompt template, the item prompt template including a task description, the specific business hour, and an output format description;
inputting a concatenated prompt into the large model to generate the augmented item temporal feature; and
replacing a temporal feature corresponding to the item in an original dataset with the augmented item temporal feature.

3. The spatiotemporal data augmentation method of claim 1, wherein summarizing features of the user includes:
replacing a specific business hour of each item in the interaction history of the user with the augmented item temporal feature obtained in step 1;
concatenating the interaction history after replacement with a user prompt template, the user prompt template including a task description, the interaction history, and an output format description; and
inputting a concatenated prompt into the large model to generate an augmented ordinary feature, an augmented temporal feature, and an augmented spatial feature.

4. The spatiotemporal data augmentation method of claim 1, wherein the step 2 further includes:
generating an interest state sequence of the user based on a historical behavior sequence of the user, the interest state sequence including a plurality of interest state segments; and
generating an interest change feature of the user based on the historical behavior sequence and the interest state sequence through the large model, the interest change feature including a category distribution across different time periods, an interest change magnitude between adjacent time periods, and a temporal weight.

5. The spatiotemporal data augmentation method of claim 1, wherein generating the positive and negative sample pairs includes:
concatenating the interaction history of the user and the candidate item set with a user-item prompt template, the user-item prompt template including a task description, the interaction history, the candidate item set, and an output format description;
scoring all items using the base recommendation model and ranking the items in a descending order, and selecting top 5 ranked items as a positive sample candidate set and selecting a plurality of items from top 10% ranked items as a negative sample candidate set, and
inputting a concatenated prompt into the large model to generate the positive and negative sample pairs.

6. The spatiotemporal data augmentation method of claim 1, wherein encoding and dimensionality reduction in step 4 includes:
encoding augmented text features into the high-dimensional vectors using the large model as the encoding layer;
performing the dimensionality reduction on the high-dimensional vectors using the linear layer with dropout to obtain the feature vector after the dimensionality reduction.

7. The spatiotemporal data augmentation method of claim 1, wherein step 5 further includes:
performing L2 normalization on the feature vector after the dimensionality reduction prior to the weighted fusion to eliminate scale differences among different features.

8. The spatiotemporal data augmentation method of claim 7, wherein using the BPR loss function in step 6 includes:
inputting the comprehensive representation generated in step 5 into the BPR loss function without sample pruning;
merging the augmented samples with the original training set at a preset ratio to form the final training set; and
controlling a proportion of the augmented samples in the final training set to prevent impact of noise on the training of the recommendation model.

9. The spatiotemporal data augmentation method of claim 8, wherein the step 6 further includes:
determining, based on a historical interaction record and historical contextual information, a proportion of a plurality of augmented samples corresponding to the historical interaction record in the final training set.

10. The spatiotemporal data augmentation method of claim 9, wherein the determining, based on a historical interaction record and historical contextual information, a proportion of a plurality of augmented samples corresponding to the historical interaction record in the final training set includes:
determining, based on the historical contextual information and the historical interaction record, a confidence score for each historical interaction in the historical interaction record through a confidence assessment unit;
determining a proportion range based on the historical interaction record; and
determining the proportion based on the proportion range and the confidence score.

11. The spatiotemporal data augmentation method of claim 10, wherein the step 6 further includes:
performing constraint processing on the proportion, the constraint processing including at least one of upper and lower bound constraint processing, proportional scaling processing, or smoothing processing.

12. The spatiotemporal data augmentation method of claim 1, wherein applying the sample pruning strategy in step 7 includes:
inputting the temporal features and the spatial features from the item features and the user features after the dimensionality reduction into the BPR layer with pruning;
performing sample pruning to remove a portion of easily distinguishable training triples using the temporal features and the spatial features; and
obtaining the second loss function by processing four different combinations of the temporal features and the spatial features respectively through four BPR loss functions, wherein the sample pruning strategy is applied after processing by each of the four BPR loss functions.

13. The spatiotemporal data augmentation method of claim 1, wherein fusing the first loss function and the second loss function in step 8 includes:
obtaining the total loss function by fusing the first loss function obtained in step 6 and the second loss function obtained in step 7 according to the preset weight; and
optimizing the training of the recommendation model using the total loss function to improve performance of the recommendation system.

14. The spatiotemporal data augmentation method of claim 1, further comprising:
deploying a trained recommendation model to an online recommendation system;
generating an item recommendation result for a target user by processing a real-time interaction record of the target user through the trained recommendation model;
determining, based on the item recommendation result, a recommended item set and a layout parameter of the recommended item set;
generating, based on the layout parameter, a rendering instruction and sending the rendering instruction to a user terminal, the rendering instruction including a coordinate mapping and a layer hierarchy of each item in the recommended item set; and
controlling, based on the rendering instruction, the user terminal to invoke a graphics processing unit to draw a graphical interface element of each item in a frame buffer according to the coordinate mapping and the layer hierarchy.

15. The spatiotemporal data augmentation method of claim 14, wherein the item recommendation result includes a predicted interaction probability for each item, the method further comprises:
generating a preloading instruction based on the predicted interaction probability and sending the preloading instruction to the user terminal, the preloading instruction including a memory priority of each item in the recommended item set; and
controlling, based on the preloading instruction, the user terminal to perform hierarchical memory allocation for the item based on the memory priority.
